(19) United States
(12) Patent Application Publication
(10) Pub. No.: US 2026/0074884 A1
(43) Pub. Date: Mar. 12, 2026

(54) DATA SCHEME FOR DYNAMIC ENCRYPTION

(71) Applicant: MASTERCARD INTERNATIONAL INCORPORATED, Purchase, NY (US)

(72) Inventors: Preeti RAWAT, Co. Dublin (IE); Prasan PAI, Brambleton, VA (US); Shrill SHRESTHA, Arlington, VA (US)

(73) Assignee: MASTERCARD INTERNATIONAL INCORPORATED, Purchase, NY (US)

(21) Appl. No.: 18/830,144

(22) Filed: Sep. 10, 2024

(51) Int. Cl. H04L 9/08

(52) U.S. Cl. CPC H04L 9/0819

(57) ABSTRACT

A system may access a data model comprising a plurality of field names and, for each field name from among the plurality of field names, a target encryption state that indicates whether data identified by the field name is to be encrypted. The system may receive an encryption trigger. The system may, responsive to the encryption trigger, for each encryption event from among one or more encryption events: identify a target encryption state for the data based on the data model, and execute an encryption process on the data based on the target encryption state. The encryption process may cause the data to be in the target encryption state.

### BACKGROUND

Application-Level Encryption (“ALE”) may be required to encrypt highly confidential data. This is because Disk-Level Encryption or Transparent Data Encryption may be insufficient to protect data. In some instances, specific fields in a data record may require encryption while others do not. Furthermore, encryption requirements can vary over time or specific application. Thus, depending on the timing and/or context, certain fields may require encryption while other fields may no longer require encryption.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment for dynamically encrypting or decrypting data based on a data model;

FIG. 2 illustrates a schematic example of a data model for dynamic encryption;

FIG. 3 illustrates an example of a method for data encryption based on a data model;

FIG. 4 illustrates an encryption process for a key rotation event;

FIG. 5 illustrates an example of a method of an encryption process for an new column event;

FIG. 6 illustrates an example of a method of an encryption process for a column removal event;

FIG. 7 illustrates an example of a method of an encryption process for a new row event;

FIG. 8 illustrates another example of a method for data encryption based on a data model; and

FIG. 9 illustrates an example of a computer system that may be implemented by devices illustrated in FIG. 1.

### DETAILED DESCRIPTION

The disclosure relates to a data encryption scheme and corresponding systems and methods thereof. Data encryption imposes a computational burden both when encrypting and decrypting data. While it may be secure to simply encrypt all data, it may not be computationally feasible to do so, particularly for large scale data handled by modern datastores such as relational databases and filesystems. Because encryption for some data may be unnecessary, it is more computationally efficient to encrypt some but not all data. However, it may be difficult for encryption systems to identify data fields that should and/or must be encrypted. Furthermore, data encryption requirements may vary over time and/or depending on the context. For example, a new data field may be added to a datastore and that new data may require encryption. On the other hand, a data field may be removed from the datastore or otherwise no longer require encryption. Likewise, a data policy may require a person's name be encrypted today but not have a similar requirement in a year. The data policy may require that a person's name be encrypted only when stored with other information about that person. Furthermore, one application may require encrypting the person's name while another application may not.

The system may address these and other issues with data encryption based on a data encryption scheme that enforces target encryption states. A target encryption state is a required or desired encryption property of data, such as whether the data should be encrypted, the type of encryption to be used, and/or other encryption state. The data encryption scheme may use a data model that stores target encryption states. The data model may, for each data field, store an identification of the data field and its corresponding target encryption state. The system may, periodically and/or on-demand, identify the target encryption state of a data field and then encrypt or decrypt the data field accordingly. In this manner, depending on the timing and/or context, the system may encrypt or decrypt data according to its individualized target encryption state as specified by the data model.

To do so, the system may access the data from a datastore. The datastore may include a database, a filesystem, and/or other type of electronic data storage system. A database may include tables that use rows and columns. In this example, encrypted data may be stored as values in a column that is part of a row in a table. The data model may store a target encryption state for each column, each row, and/or each table. A filesystem may organize the data into directories and files that are stored on different sectors of a physical storage medium such as disk storage. In this example, encrypted data may be stored as encrypted files or encrypted values within a file. The data model may store a target encryption state for each directory, each file, and/or each part of a file (such as specific data fields in the file).

Whichever type of datastore is used, the encrypted data may be encoded and stored as an aggregate of a key-alias, a nonce, a tag, and cipherText. The aggregate may include a concatenation of the foregoing data so that when accessed, each of the key-alias, the nonce, the tag, and the cipherText may be decoded from the concatenated data. The key-alias is an identifier used to identify the cryptographic key used to encrypt the data into cipherText. The nonce may include a 12 byte nonce that includes sixteen base64 encoded characters. The tag may include a 16 byte tag that includes twenty-two base64 encoded characters. The cipherText is the encrypted data using the cryptographic key identified by the key-alias.

Each application (also referred to interchangeably herein as a “module”), in the system may perform ALE using the data model. ALE encrypts data within the application, before the data is transmitted or stored. For example, each module may consult the data model to identify target encryption states of the data and then perform ALE on the data based on the data model. In some examples, each module may perform this encryption process on demand. In some examples, the system may periodically perform this encryption process. For example, the system may execute a daemon or other computer process on an hourly, nightly and/or other periodic basis to perform the encryption process.

In some examples, the system may ensure that the current encryption state of the data matches its target encryption state. One or more encryption events may cause data to deviate from target encryption states. Examples of the encryption events will be described in the context of data stored in database tables for illustration. Similar encryption events can occur in other types of datastores as well.

Encryption events may include a key rotation event, a new column event, a column removal event, and a new row event. A key rotation event occurs when the encryption system replaces an encryption key used for encryption with a new encryption key. Key rotation improves security by mitigating against compromised keys, but can result in data being encrypted using stale, or old, encryption keys. In this sense, the target encryption state of the data is to be encrypted with a current encryption key. The system described herein may address this problem by identifying encrypted data based on the data model, decrypting the data using the prior encryption key, and then re-encrypting the data using the current encryption key.

A new column event occurs when a new column is added to a database table (or, more generally, when a new data field is added to a datastore). The new column event allows for flexibility and scalability of existing datastores, but can result in new data that has not been encrypted. The system may, based on the data model, detect the new column event, obtain a current encryption key, and ensure that the data in the new column complies with its corresponding target encryption state, such as by encrypting the data with the current encryption key.

A column removal event occurs when a column is to be removed from a database table (or, more generally, when a data field is to be removed from a datastore). The column removal event also allows for flexibility in removing deprecated data fields or data fields that no longer require encryption, but may result in data that remains encrypted. The system may, based on the data model, detect the column removal event, identify the encryption key used to encrypt the data (such as via the key-alias concatenated with other encryption data), and decrypt the data in the column to be removed.

A new row event occurs when a new row is added to a database table (or, more generally, when a set of data fields are to be added to a datastore). The new row event also allows for flexibility in adding data, but may result in data that is not in its target encryption state. The system may, based on the data model, detect the new row event, identify the encryption key used to encrypt the data (such as via the key-alias concatenated with other encryption data), obtain a current encryption key, and ensure that data in all columns in the new row comply with its corresponding target encryption state, such as by encrypting the data with the current encryption key.

Having described examples of system operation, a system environment for a dynamic encryption scheme will now be described.

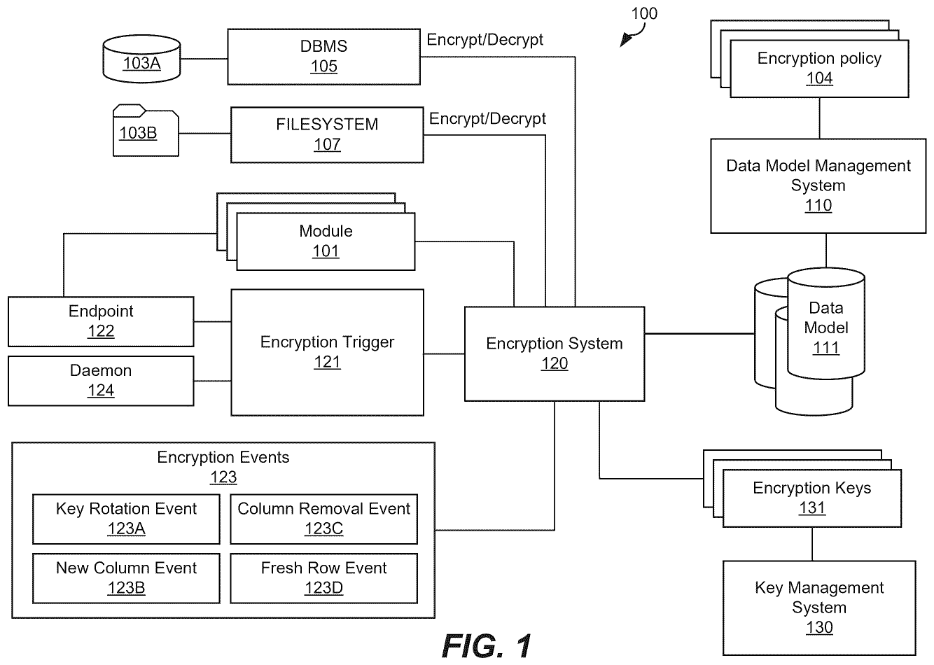

FIG. 1 illustrates an example of a system environment 100 for dynamically encrypting or decrypting data 103 based on a data model 111. The system environment 100 may include a plurality of modules 101, a data model management system 110, an encryption system 120, a key management system 130, a data model 111, and/or other features. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

A module 101 is a system that uses at least some data that is to be encrypted. For example, a module 101 may be an application that uses ALE to encrypt data at rest. Data 103 is information that can be stored in computer memory using various formats, such as data records in a relational database 105 (in which data is illustrated as data 103A), files on a filesystem 107 (in which data is illustrated as data 103B), in-application data, and/or other formats. Data 103 may be encrypted using ALE. That is, in these examples, the data 103 is data at rest, and not data in transit that is transmitted via a network. On the other hand, data in transit, when encrypted, is encrypted at the network layer. Data 103 may be application-specific. That is, each module 101 may read, write, and/or update its own set of data 103. Each module 101 may partially or fully execute an encryption process described with respect to the encryption system 120.

In some examples, the data 103 is encrypted based on a data model 111. A data model 111 is a data scheme that specifies encryption targets for data 103. The data model 111 may be updated to enable real-time updates to encryption targets for the data 103. The data model 111 stores a plurality of field names and corresponding target encryption states. In some examples, the data scheme is configured as rows and columns, with each row pertaining to a particular field name and its target encryption state. In some examples, each field name and its target encryption state are stored in the data model 111 as a key-value pair.

A field name identifies a data field in the data 103. For example, a field name may include a first name, a last name, an address, a phone number, an identifier, and/or other data that can be encrypted or decrypted. A target encryption state identifies an encryption state in which the data field identified by the corresponding field name should be. Thus, the target encryption state may be used to encode encryption requirements for data fields identified by a corresponding field name. In some examples, the target encryption state is a binary value that indicates that the encryption state is to be encrypted or not encrypted (unencrypted). In these examples, the target encryption state may be configured as a data field “is_encrypted” in which a Boolean value of “1” indicates that the corresponding data is encrypted. Alternatively, the data field may be “notEncrypted” in which case the Boolean value may be set to “1” if the corresponding data is not encrypted. In other examples, the target encryption state may be any value that indicates the encryption state, including a specific type of encryption that may be required (such as when different levels of encryption are required).

The data field identified by a field name may have encryption requirements depending on the application, time, and/or other context. Some data fields may require encryption while others do not. In some instances, a data field identified by a field name may require encryption in one context but not in another context. In some instances, a data field identified by a field name may require encryption at one time point, but not another time. Thus, different data fields have different encryption requirements. Furthermore, this encryption requirement can change over time and/or depending on the context of the relevant data field. Accordingly, new field names may be added and/or existing field names may be updated to reflect changes to encryption requirements.

It should be noted that there may be different data models 111 for different applications or sets of data. For example, a first module 101 may use a first data model 111 for encryption management while a second module 101 may use a second (different) data model 111. In this way, the computer system 110 may accommodate different encryption requirements and may be customized for different systems.

A data model 111 may be generated or updated based on one or more encryption policies 104. An encryption policy 104 defines data fields that should or must be encrypted. In some examples, the encryption policy 104 defines a context, or conditions, in which particular data fields should or must be encrypted. An encryption policy 104 may be based on compliance requirements from government agencies, non-government agencies, private contracts, professional or ethical requirements, and/or other requirements for securing data through encryption. The data model management system 110 may generate and/or update the data model 111 based on these or other encryption requirements. By providing the ability to set encryption requirements for a given module 101 and/or data fields, encryption systems may be improved to be scalable and dynamic. In some examples, the data model management system 110 may receive inputs from a user. In this way, users may generate and/or update the data model 111 through the data model management system 110.

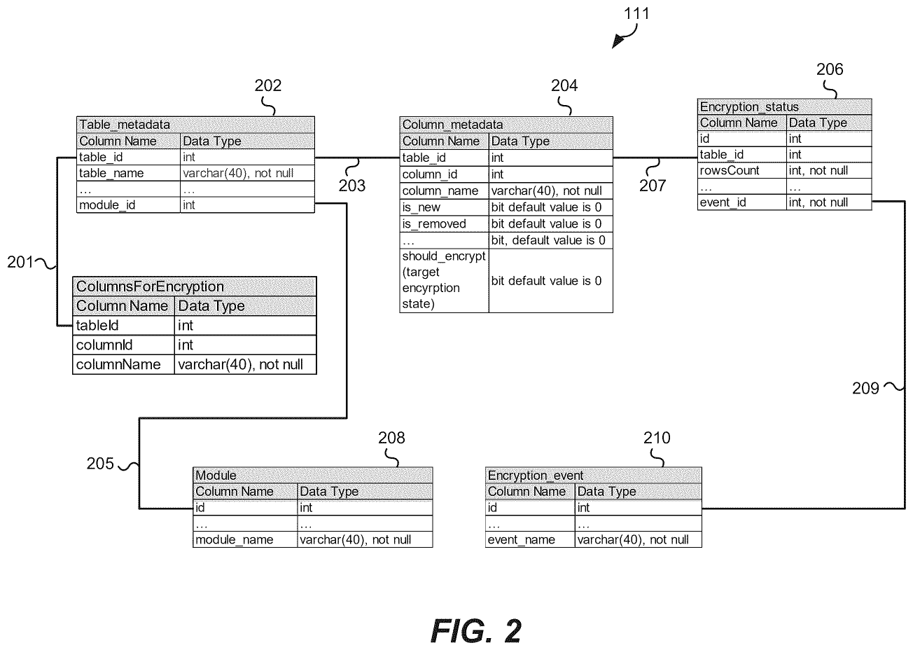

To illustrate, the data model 111 and various examples of encryption based on the data model 111 will be described in the context of data 103A stored in a relational database 105, although similar encryption events can be accounted for in other types of data 103, such as data 103B. FIG. 2 illustrates a schematic example of a data model 111 for dynamic encryption. In the illustrated example, the data model 111 includes a plurality of database tables 202, 204, 206, 208, and 210. Each table is illustrated using a database schema format in which columns (“Column Name”) and corresponding datatypes (“Data Type”) for a table is shown. In each of database tables 202, 204, 206, 208, and 210, the specific number, names, and datatypes of columns is shown for illustrative clarity. Additional columns (indicated by “ . . . ”) may be included and the names and datatypes may be changed.

As illustrated, table 202 (“Table_metadata”) includes columns of data that identify tables managed by dynamic encryption as disclosed herein and metadata about those tables. For example, table 202 includes a table_id column that stores an integer identifier that identifies a table under dynamic encryption, a table_name column that stores a variable character name of the table used in queries, and a module_id that stores an integer identifier of a module that uses the table identified by the table_id. The table_id may be used in a join 203 with the table_id column of the table 204, which stores data about columns in a table managed by dynamic encryption. The module_id may be used in a join 205 with the id column of table 208 that stores data about the module.

As illustrated, table 204 (“Column_metadata”) includes columns that store data about each column in tables managed by dynamic encryption. For example, the table 204 includes a table_id column that stores an integer identifier that identifies the table managed by dynamic encryption, a column_id column that stores an integer identifier that identifies the column that is to be encrypted or decrypted, a column_name column that stores a variable character name of the column used in queries, an is_new column that stores a bit value indicating whether the column is new (resulting from a column addition event), an is_removed column that stores a bit value indicating whether the column is to be removed (resulting from a column removal event), and a should_encrypt column that stores a bit value indicating a target encryption state. In this example, target encryption state is a bit (binary) value that indicates a whether or not (yes or no) the data in the corresponding column identified by column_id should be encrypted. However, the target encryption state may include other values such as a variable character value that indicates other types of target encryption states, such as the type of encryption to be used.

The table_id may be used in a join 207 with the table_id column of the table 206, which stores data about the encryption status of rows in a table managed by dynamic encryption. The module_id may be used in a join 205 with the id column of table 208 that stores data about the module.

As illustrated, table 206 (“Encryption_status”) includes columns that store data about the encryption status of a table managed by dynamic encryption. For example, the table 206 includes an id column that stores an integer identifier that identifies the encryption status entry, a table_id column that stores an integer identifier that identifies the table managed by dynamic encryption and to which the encryption status entry relates, a rowsCount column that stores an integer value that indicates the number of rows associated with the encryption status, and an event_id column that stores an integer identifier that identifies an encryption event (such as an encryption event 123 illustrated in FIG. 1) to which the encryption status relates. The event_id may be used in a join 209 with the event_id column of the table 210, which stores data about the encryption events 123.

As illustrated, table 210 (“Encryption_event”) includes columns that store data about the encryption events 123. For example, the table 210 includes an id column that stores an integer identifier that identifies the encryption event and an event_name column that stores a variable character name of the encryption event.

As illustrated, table 208 (“Module”) includes columns that store data about modules 101 that may use the data model 111 for ALE using dynamic encryption described herein. For example, the table 208 includes an id column that stores an integer identifier that identifies the module 101 and a module_name column that stores a variable character name of the module 101.

Encryption with Key Rotation

Returning to FIG. 1, the encryption system 120 may encrypt data 103 based on the data model 111, one or more encryptions key 131, and one or more encryption algorithms. Each module 101 may use the encryption system 120 to perform ALE. An encryption key 131 is data, such as a string of bits, that is used to control an output of the encryption algorithm. In particular, an encryption key 131 controls how the encryption algorithm transforms unencrypted data such as plaintext to encrypted data such as ciphertext. An encryption algorithm is a computational function that converts unencrypted data into encrypted data such as ciphertext. The encryption system 120 may use symmetric and/or asymmetric encryption. In symmetric encryption, the same encryption key 131 is used for both encrypting and decrypting data. Examples include, without limitation, Advanced Encryption Standard (“AES”), Data Encryption Standard (“DES”), Triple DES (“3DES”), and Rivest Cipher 4 (“RC4”).

In asymmetric encryption, two different but encryption keys 131 are used: a public key and a corresponding private key that is mathematically related to the public key. The public key can be published and may be used to encrypt data while the private key is kept secret and is used to decrypt data that was encrypted using the corresponding public key. Examples include, without limitation, Rivest-Shamir-Adleman (“RSA”), Elliptic Curve Cryptography (“ECC”), and Digital Signature Algorithm (“DSA”).

In some examples, the encryption system 120 may implement key rotation via encryption keys 131 that are rotated. In these examples, the key management system 130 may periodically generate new encryption keys 131 to replace previously used ones. In this way, security may be improved to mitigate encryption keys 131 that have been compromised.

The encryption system 120 may access the new encryption key 131 and use the new encryption key 131 to encrypt new data. Because the encryption keys 131 change over time, the encryption system 120 may store an identification, such as a key alias, that identifies the encryption key 131 used to encrypt the data. In this manner, the encryption system 120 may be able to decrypt encrypted data that was encrypted using a prior encryption key 131. A key rotation event 123A occurs when a new encryption key 131 is generated. This may result in some data 103 in the datastore to be encrypted using a potentially compromised (older) encryption key 131.

Dynamic Encryption Based on a Data Scheme with Target Encryption States

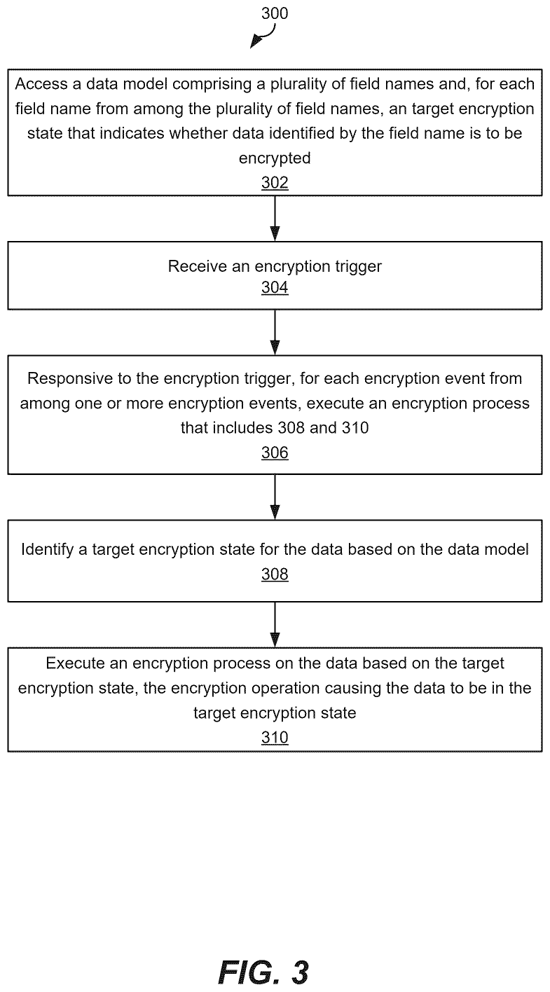

The encryption system 120 may encrypt and/or decrypt the data 103 so that the encryption states match the respective target encryption states specified by the data model 111. The encryption system 120 may be triggered to do so responsive to an encryption trigger 121. An encryption trigger 121 may include an on-demand trigger from an endpoint 122 (such as a module 101 that initiates the encryption process), a periodic trigger from a daemon 124 or other process that automatically initiates the encryption process at regular intervals, and/or other triggers. Triggering the encryption system 120 may ensure that the encryption states are current and/or account for any changes to the data model 111 that may have occurred since a prior execution of the encryption process. To illustrate, an encryption process of the encryption system 120, which may be executed by a module 101, will be described with respect to FIG. 3.

FIG. 3 illustrates an example of a method 300 for data encryption based on the data model 111. The method 300 may cause data 103 to be its target encryption state as specified by the data model 111. At 302, the method 300 may include accessing the data model 111. The data model 111 comprising a plurality of field names and, for each field name from among the plurality of field names, a target encryption state that indicates whether data identified by the field name is to be encrypted. At 304, the method 300 may include receiving an encryption trigger 121. Each field name may correspond to a column_name or column_id in the data model 111 when the data model 111 is configured as a database.

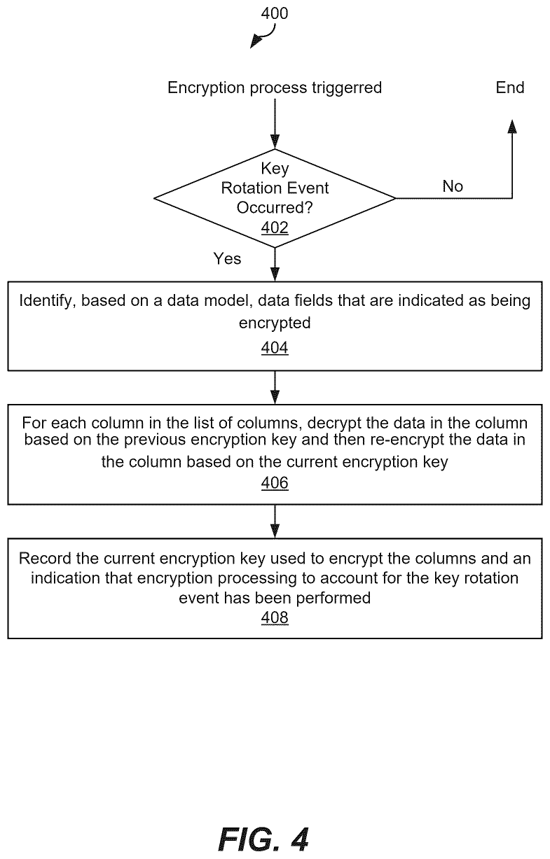

Responsive to the encryption trigger 121, at 306, the method 300 may include, for each encryption event 123 from among one or more encryption events (123A-D), executing an encryption process. Examples of encryption processes responsive to respective encryption events 123A-D are illustrated in FIGS. 4-7.

An encryption event 123 is an occurrence of an event that may change the target encryption state of the underlying data 103. Examples of an encryption event 123 may include a key rotation event 123A, a new column event 123B, a column removal event 123C, a new row event 123D, and/or other types of events. Each of these examples of encryption events 123 (such as 123A-D) may result in data 103 that is not in its target encryption state (including new or updated columns or rows that should be assessed for their target encryption state). For example, a key rotation event 123A occurs when encryption keys 131 are periodically updated so that data is periodically encrypted with a new encryption key 131. Thus, when a key rotation event 123A occurs, the encryption process will automatically take this into account to re-encrypt encrypted data based on the new encryption key 131. A new column event 123B occurs when a new column is added to a table. Unencrypted data stored in the new column therefore may not be in its target encryption state. A column removal event 123C occurs when a column is to be removed from a table. A new row event 123D occurs when a row of columns is to be updated.

Generally speaking, encryption processes may ensure that the data 103 is in respective target encryption states in accordance with any encryption events 123 that may have taken place. For example, at 308, the method 300 may include identifying a target encryption state for the data 103 based on the data model 111.

At 310, the method 300 may include executing an encryption process on the data based on the target encryption state, the encryption process causing the data to be in the target encryption state. The encryption process may include encrypting the data 103 if the target encryption state is to be encrypted and the current encryption state is unencrypted. Alternatively, the encryption process may include decrypting the data 103 if the target encryption state is to be unencrypted and the current encryption state is encrypted. In another example, the encryption process may include re-encrypting the data 103 with a new encryption key if the target encryption state is an updated encryption state based on encryption key rotation. In another example, the encryption process may include decrypting the data 103 for removal if the data is to be removed.

For example, FIG. 3 illustrates an example of a method for data encryption based on a data model 111. FIGS. 4-7 respectively illustrate examples of encryption processes for various encryption events 123A-D. The examples in these figures will refer to the data model 111 illustrated in FIG. 2. Specific examples of encryption processes for various encryption events 123 will be described in the context of a table called “Supplier” and examples of values in the Supplier table respectively illustrated in Tables 1 and 2 below for illustrative purposes. Other tables, rows, columns, and their respective values may be used.

FIG. 4 illustrates an example of an encryption process 400 for a key rotation event 123A. At 402, the encryption process 400 may include determining whether the key rotation event 123A has occurred. For example, the encryption process 400 may include accessing an old key alias that identifies an old encryption key and a new key alias that identifies a new encryption key. If the current key alias stored in the data model 111 matches the current key alias, then a key rotation event 123A has not occurred since the last check, meaning that the encryption key used to encrypt data 103 is the new (current) encryption key, and the encryption process 400 may exit. If not (the value of the current key alias stored in the data model 111 does not match the new key alias and/or matches the old key alias), then a key rotation event has occurred since the last check and the encryption process 400 may proceed to 404.

At 404, the encryption process 400 may include identifying, based on the data model 111, one or more columns that are indicated as being encrypted. For example, the encryption process 400 may include identifying rows and its columns for which an encryption status indicates that the data stored in the columns are encrypted. In particular, the encryption process 400 may include identifying rows in a table that are stored with an is_encrypted flag set to 1. The result will be a list of one or more columns that may be encrypted and therefore should be re-encrypted using a new encryption key that was created during the key rotation event.

At 406, the encryption process 400 may include, for each column in the list of columns, decrypting the data in the column based on the previous encryption key and then re-encrypting the data in the column based on the current encryption key. Encryption and decryption may be performed as described with respect to the encryption system 120.

When decryption and re-encryption is performed for the identified rows and each column of each identified row, at 408, the encryption process 400 may include recording the current encryption key used to encrypt the columns and an indication that encryption processing to account for the key rotation event has been performed. For example, the column_id may be stored in association with the key alias or other identifier of the current encryption key. In particular, the encrypted data in the column may have stored values in the encrypted field, such as the key alias, a base64_nonce (12 byte Nonce), a base_64 tag (16 byte tag), and base64_cipherText (cipherText).

FIG. 4B illustrates an example of a method 400B of an encryption process for a key rotation event 123A for dynamic columns. The encryption process may execute the method 400B to account for key rotation events 123A on dynamic columns. At 412, the method 400B may include determining whether the key rotation event 123A has occurred. For example, the method 400B may include accessing an old key alias that identifies an old encryption key and a new key alias that identifies a new encryption key. If the current key alias stored in the data model 111 matches the current key alias, then a key rotation event has not occurred since the last check, meaning that the encryption key used to encrypt data 103 is the new (current) encryption key, and the method 400B may exit. If not (the value of the current key alias stored in the data model 111 matches the old encryption key), then a key rotation event has occurred since the last check and the method 400B may proceed to 414.

At 414, the method 400B may include identifying, based on the data model 111, a list of one or more dynamic columns which encryption is permitted. The results may be a list of one or more columns for which encryption is permitted.

The method 400B may include reading all rows for which is_encrypted=1 for table SEImportRow such as by executing a select query over SEImportRow in which is_encrypted=1 and value!=null, store that information in the format: var V=List<SEImportRow>, where values is the list of values that are taken into consideration for key-rotation.

At 416, the method 400B may include, for each dynamic column in the list of dynamic columns, decrypting the data in the dynamic column based on the previous encryption key and then re-encrypting the data in the dynamic column based on the current encryption key. Encryption and decryption may be performed as described with respect to the encryption system 120.

When decryption and re-encryption is performed for the identified rows and each dynamic column of each identified row, at 418, the method 400B may include recording the current encryption key used to encrypt the dynamic columns and an indication that encryption processing to account for the key rotation event has been performed.

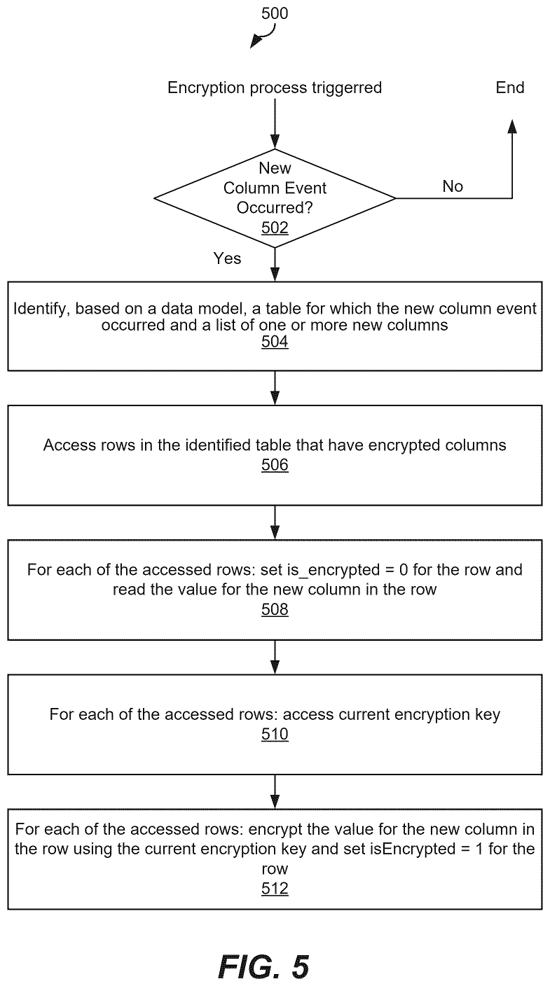

FIG. 5 illustrates an example of a method 500 of an encryption process for an new column event 123B. The new column event 123B will be illustrated as a hypothetical scenario in which the column “Phone Number” is added to a hypothetical “Supplier” table. When the “Phone Number” column is added to the “Supplier” table, an entry in table 204 illustrated FIG. 2 (“Column_metadata”) will be created to indicate the addition as illustrated below. Only relevant entries and columns for the Column_metadata are shown for clarity.

Table 1. Example of relevant portions of row and column values for the Column_metadata table for illustrating the new column event 123B.

Column_metadata

| | | Column | | | |
|---|---|---|---|---|---|
| Id | table_id | Name | should_encrypt | is_new | is_removed |
| 1 | 222 | Supplier | 1 | 0 | 0 |
| | | Name | | | |
| 2 | 222 | Address | 1 | 0 | 1 |
| 3 | 222 | Phone | 1 | 1 | 0 |
| | | Number | | | |
| 4 | 222 | Supplier | 0 | 0 | 0 |
| | | ID | | | |

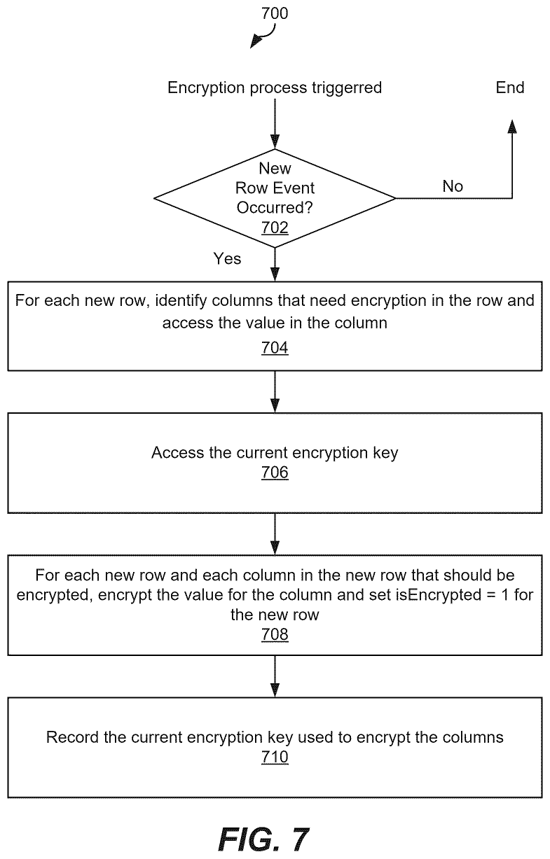

Table 2. Example of relevant portions of a hypothetical “Supplier” table for which a new column “Phone Number” is added. “****” values indicates data value is encrypted. As shown, the Supplier table has 8 rows, each corresponding to a Supplier. Columns in this table store data about the Supplier identified by the “Supplier ID” column. The values in the phone number column are not encrypted because the column is new. The method 500 will detect the new column and encrypt the appropriate values. It should be noted that Supplier IDs 1-4 are encrypted but Supplier IDs 5-8 are not. This is because Supplier IDs 5-8 represent new rows from a new row event, which will be detected and handled as illustrated in FIG. 7.

Supplier Table

| Supplier | Supplier | | | |
|---|---|---|---|---|
| ID | Name | Address | Phone Number | is_encypted |
| 1 | ******* | ***** | 888-555-1236 | 1 |
| 2 | ******* | ***** | 888-555-6422 | 1 |
| 3 | ******* | ***** | 888-555-0870 | 1 |
| 4 | ******* | ***** | 888-555-0409 | 1 |
| 5 | ABC co | . . . Arlington . . . | 888-555-0345 | 0 |
| 6 | Bob's | . . . Dublin . . . | 888-555-6451 | 0 |
| | Bakery | | | |
| 7 | Sally's | . . . Pune . . . | 888-555-8334 | 0 |
| | Sugar | | | |
| 8 | Jane's | . . . London . . . | 888-555-6644 | 0 |
| | Burgers | | | |

At 502, the method 500 may include determining whether a new column event 123B has occurred based on the data model 111, such as when a new column has been added to the data 103A. To make this determination, for example, the method 500 may execute a query on table 204 (“Column_metadata”) in which is_new=1 and should_encrypt=1 will return a list of one or more new columns that should be encrypted. If there are no new columns (such as when the query returns NULL), the method 500 may exit.

If there are new columns according to the table 204, at 504, the method 500 may include identifying, based on the data model 111, a table for which the new column event occurred and a list of one or more new columns in that table. For example, if there are new columns, the query executed at 502 will return a table identifier (“table_id”) that identifies a table in the data 103A having a new column and a column identifier (“column_id”) that identifies the new column. The table_id may be used to identify the corresponding Supplier table by querying table 202 (“Table_metadata”) illustrated in FIG. 2. It should be noted that this query may be a separate query to the Table_metadata or may be a single query made through a join or similar function. Other tables described herein throughout may be similarly queried individually or joined to reduce individual queries. In this case, the column “Phone Number” in table “Supplier” (table_id=222) will be identified (is_new=1 and should_encrypt=1 as shown in Table 1).

At 506, the method 500 may include accessing rows in the identified table that have encrypted columns. Continuing previous example, the Supplier table may be a pre-existing table in the data 103A that is modified to include an is_encrypted column to function with the data model 111 for dynamic encryption disclosed herein. Other tables may be similarly modified to function with the data model 111 for dynamic encryption. In this example, rows having is_encrypted set to 1 (or other value indicating that the row is encrypted) may be accessed.

At 508, the method 500 may include, for each of the rows, setting is_encrypted=0 for the row and reading the value for the new column in the row. In this case, the method 500 may, for each row corresponding to Supplier IDs 5-8 (in which is_encrypted=1), set the is_encrypted value to 0, and read the phone number value for the new column “Phone Number.”

At 510, the method 500 may include accessing the current encryption key. For example, the method 500 may include accessing the latest key alias name and accessing the current encryption key used by the key management system 130 based on the latest key alias.

At 512, the method 500 may include, for each row, encrypting the value for the new column in the row using the current encryption key and then setting the is_encrypted=1 for the row. For example, the method 500 may encrypt each of the phone numbers in the rows corresponding to Supplier IDs 1-4. The result of processing the Supplier table illustrated in Table 2 above is shown in Table 3.

Table 3. Result of encryption processing for a new column event on the Supplier table. Note that phone numbers and other column values corresponding to Supplier IDs 5-8 remain unencrypted, which will be encrypted based on processing a new row event illustrated in FIG. 7.

Supplier Table

| Supplier | Supplier | | | |
|---|---|---|---|---|
| ID | Name | Address | Phone Number | is_encypted |
| 1 | ******* | ******* | ******* | 1 |
| 2 | ******* | ******* | ******* | 1 |
| 3 | ******* | ******* | ******* | 1 |
| 4 | ******* | ******* | ******* | 1 |
| 5 | ABC co | . . . Arlington . . . | 888-555-0345 | 0 |
| 6 | Bob's | . . . Dublin . . . | 888-555-6451 | 0 |
| | Bakery | | | |
| 7 | Sally's | . . . Pune . . . | 888-555-8334 | 0 |
| | Sugar | | | |
| 8 | Jane's | . . . London . . . | 888-555-6644 | 0 |
| | Burgers | | | |

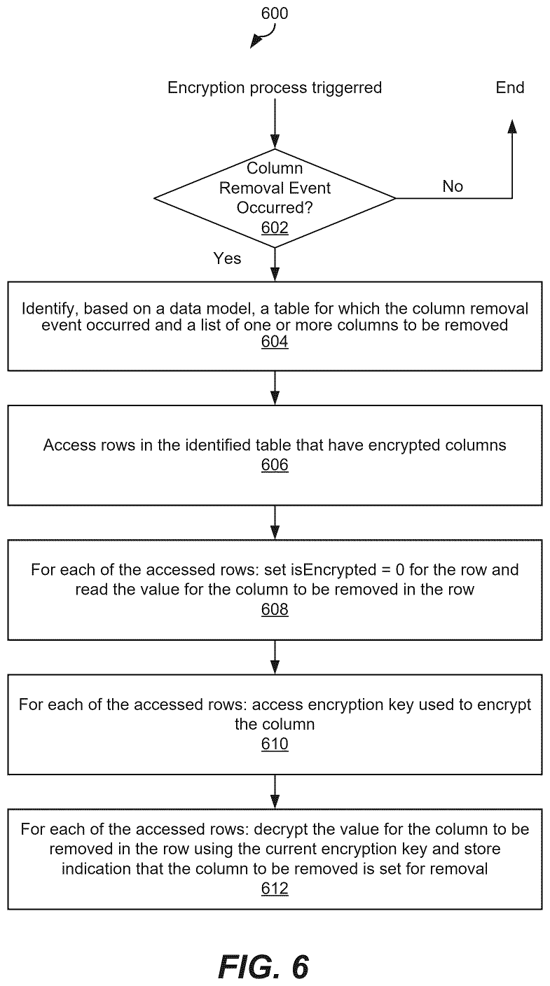

FIG. 6 illustrates an example of a method 600 of an encryption process for a column removal event 123C. At 602, the method 600 may include determining whether a column removal event 123C has occurred based on the data model 111, such as when a column is to be deleted from the data 103A. To make this determination, for example, the method 500 may execute a query on table 204 (“Column_metadata”) in which is_removed=1 and is_encrypted=1 for the identified table. The query will return a list of one or more columns that are to be removed. If there are no columns to be removed (such as when the query returns NULL), the method 600 may exit.

If there are columns to be removed according to the table 204, at 604, the method 600 may include identifying, based on the data model 111, a table for which the column removal event occurred and a list of one or more columns to be removed from that table. For example, if there are columns to be removed, the query executed at 602 will return a table identifier (“table_id”) that identifies a table in the data 103A having a column to be removed and a column identifier (“column_id”) that identifies the new column. The table_id may be used to identify the corresponding Supplier table by querying table 202 (“Table_metadata”) illustrated in FIG. 2. It should be noted that this query may be a separate query to the Table_metadata or may be a single query made through a join or similar function. Other tables described herein throughout may be similarly queried individually or joined to reduce individual queries. In this case, the column “Phone Number” in table “Supplier” (table_id=222) will be identified (is_removed=1 and is_encrypted=1 in the Supplier table).

At 606, the method 500 may include accessing rows in the identified table that have encrypted columns. Continuing previous example, the Supplier table may be a pre-existing table in the data 103A that is modified to include an is_encrypted column to function with the data model 111 for dynamic encryption disclosed herein. Other tables may be similarly modified to function with the data model 111 for dynamic encryption. In this example, rows having is_encrypted set to 1 (or other value indicating that the row is encrypted) may be accessed.

At 608, the method 500 may include, for each of the rows, setting is_encrypted=0 for the row and reading the value for the new column in the row.

At 610, the method 600 may include accessing the encryption key used for encrypting the data. For example, the method 600 may include accessing the recorded key alias name or other key identifier recorded at 408 when the column was encrypted.

At 612, the method 500 may include, for each row, decrypting the value for the new column in the row using the encryption key and storing an indication that the column to be removed is set for removal. Once this indication is stored, the column to be removed and its contents is removed from the table.

FIG. 7 illustrates an example of a method 700 of an encryption process for a new row event 123D. New row events 123D may result in rows of data 103A that should be encrypted based on the data model 111 but have not yet been encrypted. The method 700 will be illustrated in the context of new rows illustrated in Table 2, Supplier IDs 5-8.

At 702, the method 700 may include determining whether a new row event 123D has occurred based on the data model 111, such as when a new row of data has been added to the data 103A. To make this determination, for example, the method 500 may execute a query on table 204 (“Column_metadata”) in which should_encrypt=1 and for resulting tables is_encrypted=0. This will return a list of one or more rows that should be encrypted but have not yet been encrypted. For example, Supplier IDs 5-8 are new rows in the Supplier table as illustrated in Table 2. If there are no new row (such as when the query results are NULL), the method 700 may exit.

If there are new rows that need encrypting, at 704, the method 700 may include, for each of the rows, identifying columns that need encrypting in the row and accessing the data values in each of these columns.

At 706, the method 500 may include accessing the current encryption key. For example, the method 700 may include accessing the latest key alias name and accessing the current encryption key used by the key management system 130 based on the latest key alias.

At 708, the method 500 may include, for each new row and each column to be encrypted in the new row, encrypting the value for the column using the current encryption key and then setting the is_encrypted=1 for the row. For example, the method 700 may encrypt each of the phone numbers in the rows corresponding to Supplier IDs 5-8. The result of processing the Supplier table is shown in Table 4.

At 710, the method 700 may include recording the current encryption key used to encrypt the columns. For example, the column_id may be stored in association with the key alias or other identifier of the current encryption key.

Table 4. Result of encryption processing for a new row event on the Supplier table.

Supplier Table

| Supplier ID | Supplier Name | Address | Phone Number | is_encrypted |
|---|---|---|---|---|
| 1 | ******* | ******* | ******* | 1 |
| 2 | ******* | ******* | ******* | 1 |
| 3 | ******* | ******* | ******* | 1 |
| 4 | ******* | ******* | ******* | 1 |
| 5 | ******* | ******* | ******* | 1 |
| 6 | ******* | ******* | ******* | 1 |
| 7 | ******* | ******* | ******* | 1 |
| 8 | ******* | ******* | ******* | 1 |

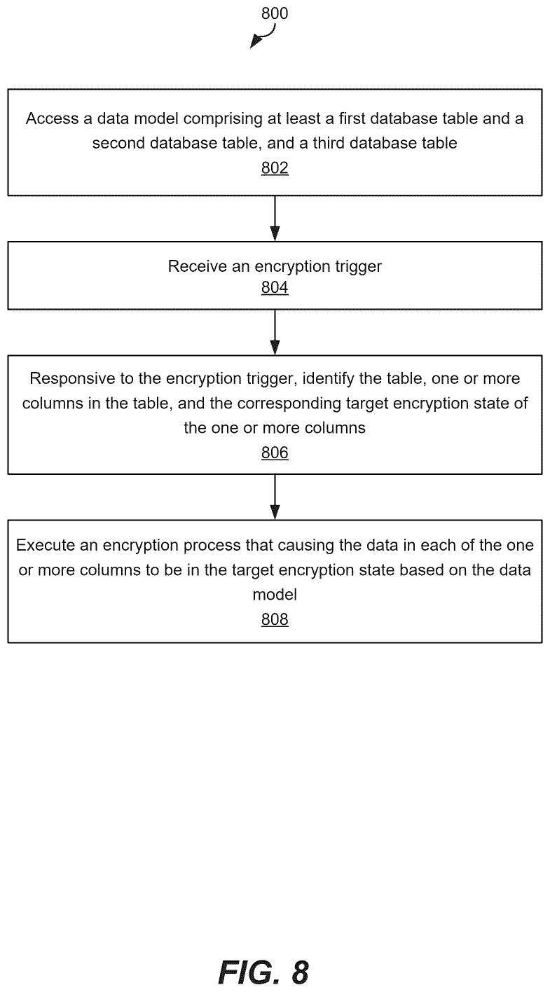

FIG. 8 illustrates another example of a method 800 for data encryption based on a data model 111. At 802, the method 800 may include accessing a data model 111 comprising at least a first database table (such as table 202 illustrated in FIG. 2) and a second database table (such as table 204 illustrated in FIG. 2). The first database table identifies a table having a plurality of columns that are subject to dynamic encryption, and the second database table stores, for each column from among the plurality of columns, a corresponding target encryption state for the data stored in that column. At 804, the method 800 may include receiving an encryption trigger. At 806, responsive to the encryption trigger, the method 800 may include identifying the table, one or more columns in the table, and the corresponding target encryption state of the one or more columns. At 808, the method 800 may include executing an encryption process that causing the data in each of the one or more columns to be in the target encryption state based on the data model

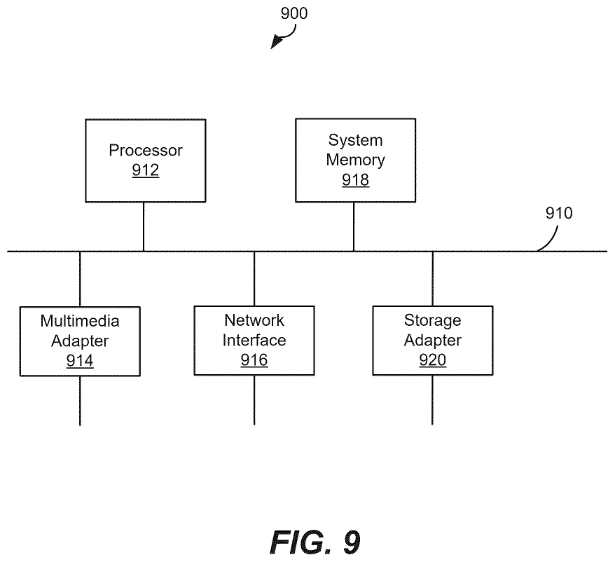

FIG. 9 illustrates an example of a computer system 900 that may be implemented by devices illustrated in FIG. 1. The computer system 900 may be part of or include the system environment 100 to perform the functions and features described herein. For example, various ones of the devices of system environment 100 may be implemented based on some or all of the computer system 900. The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 910 may allow data communication between the processor 912 and system memory 918, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remote devices over a network. The network interface 916 may include, for example, an Ethernet adapter, a Fibre Channel adapter, and/or other wired- or wireless-enabled adapter. The network interface 916 may provide a direct or indirect connection from one network element to another, and facilitate communication to and between various network elements. The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network. The devices and subsystems can be interconnected in different ways from that shown in FIG. 6. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 105) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for data model-based encryption, comprising:
a processor programmed to:
access a data model comprising a plurality of field names and, for each field name from among the plurality of field names, a target encryption state that indicates whether data identified by the field name is to be encrypted;
receive an encryption trigger;
responsive to the encryption trigger, for each encryption event from among one or more encryption events, execute an encryption process that causes the processor to:
identify a target encryption state for the data based on the data model; and
execute an encryption process on the data based on the target encryption state, the encryption process causing the data to be in the target encryption state.

2. Then system of claim 1, wherein the encryption event is a key rotation event in which a prior encryption key is replaced with a current encryption key, and wherein the processor is further programmed to:
identify, based on the data model, data that is encrypted using the prior encryption key;
access the prior encryption key;
decrypt the data using the prior encryption key;
re-encrypt the decrypted data using the current encryption key; and
store an indication of the current encryption key used to encrypt the data.

3. Then system of claim 1, wherein the encryption event is a new column event in which a new column is added to a table of a database, and wherein the processor is further programmed to:
identify, based on the data model, the new column; and
encrypt the data in the new column.

4. Then system of claim 1, wherein the encryption event is a column removal event in which a column is to be removed from a table of a database, and wherein the processor is further programmed to:
identify, based on the data model, the column to be removed; and
decrypt the data in the column to be removed.

5. Then system of claim 1, wherein the encryption event is a new row event in which a new row is added to a table of a database, and wherein the processor is further programmed to:
identify, based on the data model, the new row;
identify one or more columns in the new row to be encrypted; and
encrypt the data in each of the one or more columns.

6. The system of claim 1, wherein the processor is programmed to:
determine that a current encryption state is unencrypted and the target encryption state is encrypted, and wherein to execute the encryption process, the processor is programmed to encrypt the data.

7. The system of claim 1, wherein the processor is programmed to:
determine that a current encryption state is encrypted and the target encryption state is unencrypted, and wherein to execute the encryption process, the processor is programmed to decrypt the data.

8. The system of claim 1, wherein the processor is further programmed to:
receive an input that changes an existing target encryption state corresponding to an existing field name; and
update the data model based on the input, wherein a subsequent execution of the encryption process changes the target encryption state of the existing field name consistent with the update.

9. The system of claim 1, wherein to execute the encryption process, the processor is further programmed to:
encrypt the data based on an encryption key for application-level encryption.

10. The system of claim 1, wherein each field name and corresponding target encryption state is stored as a key-value pair in the data model.

11. A method, comprising:
accessing, by a processor, a data model comprising a plurality of field names and, for each field name from among the plurality of field names, a target encryption state that indicates whether data identified by the field name is to be encrypted;
receiving, by the processor, an encryption trigger;
responsive to the encryption trigger, for each encryption event from among one or more encryption events, executing, by the processor, an encryption process comprising:
identifying a target encryption state for the data based on the data model; and
executing an encryption process on the data based on the target encryption state, the encryption process causing the data to be in the target encryption state.

12. Then method of claim 11, wherein the encryption event is a key rotation event in which a prior encryption key is replaced with a current encryption key, the method further comprising:
identifying, based on the data model, data that is encrypted using the prior encryption key;
accessing the prior encryption key;
decrypting the data using the prior encryption key;
re-encrypting the decrypted data using the current encryption key; and
storing an indication of the current encryption key used to encrypt the data.

13. The method of claim 11, wherein the encryption event is a new column event in which a new column is added to a table of a database, the method further comprising:
identifying, based on the data model, the new column; and
encrypting the data in the new column.

14. The method of claim 11, wherein the encryption event is a column removal event in which a column is to be removed from a table of a database, the method further comprising:
identifying, based on the data model, the column to be removed; and
decrypting the data in the column to be removed.

15. The method of claim 11, wherein the encryption event is a new row event in which a new row is added to a table of a database, the method further comprising:
identifying, based on the data model, the new row;
identifying one or more columns in the new row to be encrypted; and
encrypting the data in each of the one or more columns.

16. The method of claim 11, the method further comprising:
determining that a current encryption state is unencrypted and the target encryption state is encrypted, and wherein to execute the encryption process, the processor is programmed to encrypt the data.

17. The method of claim 11, wherein the processor is programmed to:
determining that a current encryption state is encrypted and the target encryption state is unencrypted, and wherein executing the encryption process comprises decrypting the data.

18. The system of claim 1, wherein executing the encryption process comprises:
encrypting the data based on an encryption key for application-level encryption.

19. A non-transitory computer readable medium storing instructions that, when executed by a processor, program the processor to:
access a data model comprising at least a first database table and a second database table, wherein the first database table identifies a table having a plurality of columns that are subject to dynamic encryption, and the second database table stores, for each column from among the plurality of columns, a corresponding target encryption state for the data stored in that column,
receive an encryption trigger;
responsive to the encryption trigger, identify the table, one or more columns in the table, and the corresponding target encryption state of the one or more columns; and
execute an encryption process that causing the data in each of the one or more columns to be in the target encryption state based on the data model.

20. The non-transitory computer readable medium of claim 19, wherein to execute the encryption process, the instructions when executed further program the processor to:
encrypt or decrypt the data in the one or more columns depending on whether or not the data is encrypted.
